(19) United States
(12) Patent Application Publication
(10) Pub. No.: US 2026/0259003 A1
(43) Pub. Date: Sep. 3, 2026

(54) SYSTEM FOR CONTROLLING FARM OPERATIONS INCLUDING AERATION OF GRAIN STORED IN A STORAGE BIN

(71) Applicant: GGT, LLC, Madrid, NE (US)

(72) Inventor: David Lane Jantzen, Madrid, NE (US)

(73) Assignee: GGT, LLC, Madrid, NE (US)

(21) Appl. No.: 19/544,890

(22) Filed: Feb. 19, 2026

Related U.S. Application Data
(60) Provisional application No. 63/765,223, filed on Feb. 28, 2025.

(51) Int. Cl. F26B 21/37; A23B 9/20; F26B 9/06; G05B 19/042

(52) U.S. Cl. CPC F26B 21/37; A23B 9/20; F26B 9/063; G05B 19/042; F26B 2200/06; G05B 2219/25257

(57) ABSTRACT

A system for controlling farm operations including: (a) a controller configured to activate an aeration fan for aeration of grain stored in a storage bin, the controller comprising a wireless transmitter and a wireless receiver; and (b) a peripheral unit in communication with the controller, the peripheral unit comprising a base unit and an interchangeable daughter board, the base unit comprising a microcontroller, a printed circuit board, a power source, a wireless transmitter, and a wireless receiver, the daughter board configured to provide functionality specific to a selected application. The controller is further configured to wirelessly communicate with a mobile electronic device without requiring a central computer intermediary, to accept input from the mobile electronic device as a duplicate of a human-machine interface, and to push a notification to the mobile electronic device regarding a status of the aeration fan.

### CROSS-REFERENCE TO RELATED APPLICATION

This application claims priority to U.S. Provisional Application No. 63/765,223 titled “System for Controlling Aeration of Grain Stored in a Storage Bin with Aeration Fan and Current Sensor Therefor,” filed 28 Feb. 2025, which is hereby incorporated by reference in its entirety.

### TECHNICAL FIELD

The present disclosure pertains to a system for controlling farm operations including aeration of grain stored in a storage bin and, more particularly, to such a system that includes a controller with wireless communication capability, a modular peripheral unit with interchangeable daughter boards for various farm applications, and the ability to communicate with a mobile electronic device to accept input and push notifications regarding system status.

### BACKGROUND

Farms plant, grow, and harvest grain. After the grain is harvested, the grain needs to be stored. Sometimes, the grain is stored for prolonged periods of time, as the owner of the grain waits for a more optimal time to sell and transport the grain. In some instances, grain from more than one source is stored in a common location.

Grain can spoil while being stored. The spoiling of the grain can generate mold and mycotoxins. If unnoticed, those harmful byproducts can be processed with the grain and thereby enter the food supply. If noticed, the grain would have to be destroyed, which has suboptimal costs associated therewith. The presence of moisture in the air spaces around the individual pieces of grain is a primary cause of spoilage.

The moisture can develop in several ways. One way is condensation. As warm air forms within the storage facility (e.g., bin) of the grain, the warm air can contact grain that has a cooler temperature than the air. The cooler grain causes water in the warm air to condense on the grain. Another way is the release of moisture from the interior of the grain to outside of the grain—a process sometimes referred to as respiration. Grain, as harvested, has a moisture content. The presence of a moisture concentration gradient from the interior of the grain to the environment around the grain causes the moisture to diffuse to the surface of the grain.

With the reasons for spoilage understood, several conceptual goals, if achieved, should reduce the likelihood that the grain spoils. A first conceptual goal is obtaining and maintaining an equilibrium between the temperature of the grain and the temperature of the air surrounding the grain. As mentioned, condensation is the result of the grain being cooler than the surrounding air. If the temperatures are in equilibrium, then no condensation should occur, which removes a primary driver of moisture development around the grain. A second conceptual goal is a function of the combination of the ambient temperature and the ambient relative humidity (hereinafter just humidity). As the ambient temperature and ambient humidity change, so does the drive for moisture to diffuse out of the grain. When the drive is zero at any given ambient temperature and ambient humidity, the grain is said to have an equilibrium moisture content (or EMC for short). Grain with a moisture content below the EMC value will not respirate. In general, the higher the ambient temperature and the lower the ambient humidity, the lower the EMC of the grain. In contrast, the lower the ambient temperature and the higher the ambient humidity, the higher the EMC of the grain. EMC rises with increasing ambient humidity at a given ambient temperature. EMC falls with increasing ambient temperature at a given ambient humidity. The precise EMC value differs on the particular grain (e.g., corn and rice have different EMC values for a particular ambient temperature and ambient humidity). Charts for EMC are known in the art.

There are known ways to achieve these conceptual goals in order to prolong the storage life of the grain and prevent moisture development. One is to completely dry the grain with heated air and maintain it in a low moisture state via aeration (e.g., running air through the grain). However, that dries the grain more than necessary to prevent moisture and thus is a suboptimal use of energy and thus incurs unnecessary cost. Further, the excessive drying generates cracks, thereby lowering the quality of the grain. Moreover, grain is priced by weight, removing moisture reduces weight, and thus excessive drying lowers the value of the grain. Another approach is reactive based on sensed conditions. For example, aeration can be activated when a sensor (e.g., moisture, temperature, CO₂) in communication with the grain generates input that moisture is developing around the grain. However, that approach necessarily means that moisture has already developed or conditions have changed sufficiently for moisture to develop, meaning that some spoilage may have already occurred by the time aeration is initiated. In short, reactive measures by definition are lagging and may be insufficient. A preferred approach is proactive, one that aerates the grain with ambient air regularly so that the grain equilibrates with ambient conditions in a gradual manner that does not generate moisture. In general, the proactive approach aerates the grain regularly when both the ambient EMC is sufficiently near the desired moisture content for the grain and when the ambient temperature is sufficiently near a running average ambient temperature. Such an approach aerates the grain with ambient air that will not cause condensation (because the air is about the same as the temperature of the grain) and the grain will not desire to either pull in or respirate internal moisture. Such approaches were described in U.S. Pat. No. 4,522,335 (Method and Apparatus for Aeration of Stored Grain), U.S. Pat. No. 4,688,332 (Method and Apparatus for Aeration of Stored Grain), U.S. Pat. No. 4,930,229 (Method and Apparatus for Aeration of Stored Grain With Proactive Cooling), and U.S. Pat. No. 7,004,401 (System and Method for Regulating Agriculture Storage Facilities in Order to Promote Uniformity Among Separate Storage Facilities), all of which are incorporated herein by reference in their entireties.

The proactive approaches described in the aforementioned patents all utilize at least a storage bin to house the grain and an aeration fan to cause air to flow through grain. The methods/apparatuses utilize ambient temperature and ambient humidify data sources to determine whether to activate the aeration fan for a predetermined period of time. More particularly, if the data sources indicate that the ambient temperature is within an acceptable range from recent average ambient temperatures, and the EMC is within an acceptable range from the desired moisture content of the grain, then the aeration fan is activated for the predetermined period of time. If the data of the day does not indicate that the aeration would be appropriate, then the aeration time that would have occurred is “banked” until the next day and added to the predetermined period of time. As the banked time increases, the acceptable range from the recent average ambient temperature and the acceptable range from the desired moisture content of the grain is broadened to ensure that some aeration periodically takes place at the best possible time. Special adjustments can be made in the fall season heading into winter, and to account for climates that are comparatively hot or cold. A controller in communication with the data sources and the aeration fan is programmed to make those decisions. Notably, sensors for the temperature and humidity of the grain are not required, since the approach is proactive rather than reactive. One of the references ('229 patent) does describe that a grain temperature sensor can be utilized as part of an override feature where the farmer can activate the aeration fan to use up banked time if the temperature of the grain is determined to be greater than the running ambient temperature average by a relatively large amount (e.g., >9 degrees F.). Another one of the references ('401 patent) describes that a static pressure sensor at the aeration fan can be useful to determine how full the storage bin is, which may be useful for determining adjustments to the sensed current ambient temperature.

Notably, the proactive approaches described in the aforementioned patents address a problem associated with reactive aeration systems that rely on sensors disposed within the storage bin and in contact with the grain. Such reactive systems may require temperature sensors, moisture sensors, or other sensors to be installed inside the storage bin, which in turn requires cables or leads to run from those sensors to the controller. The installation of such cables can be time-consuming, costly, and customized for each storage bin configuration. In contrast, the proactive approaches rely primarily on ambient temperature and ambient humidity sensors located outside the storage bin, combined with EMC calculations, to determine when to activate the aeration fan. Because the proactive approach approximates the temperature of the grain from the running average ambient air temperature and determines appropriate aeration conditions from the EMC corresponding to ambient conditions, sensors within the storage bin in contact with the grain are not required for the system to function. The grain temperature sensors described in the '229 patent, for example, are utilized as part of an optional override feature rather than as a required component for the proactive aeration method. In this manner, the proactive approaches may avoid the need for cables running into the storage bin.

The proactive approaches described in the aforementioned patents utilize a control apparatus that includes a control box attached to an external face of a side wall of a storage bin. The control box includes a visual display and an input key panel for operator input of controller functions, such as grain type, desired grain moisture level, and desired time of daily fan operation. The control box contains a microprocessor, memory, and other circuitry for performing the information processing required by the control system. An ambient air temperature sensing device, an ambient relative humidity sensing device, and optionally a grain temperature sensing probe are all connected to the control box by respective leads. A control lead extends from the control box to an aeration fan for selective operation of the aeration fan.

However, despite the beneficial nature of the apparatus and methods of those aforementioned patents, several problems arise.

First, a chokepoint is the aeration fan. If the aeration fan becomes inoperable or operable with decreased air flow capacity, then the proactive measures to prevent spoilage fail. The farmer or other operator may not know that the fan has malfunctioned before such spoilage occurs.

Second, the human-machine interface of the prior art systems is limited to the control box attached to the storage bin. The operator must be physically present at the storage bin to view the display and receive information about the system's status. If the operator is away from the storage bin for an extended period, or simply desires the convenience of knowing the information the controller can provide without physically traveling to the control box, the operator has no means of obtaining that information. For example, if the aeration fan malfunctions or operates suboptimally while the operator is away, the operator may not learn of the problem until returning to the control box, by which time spoilage of the grain may have already occurred.

Third, the control apparatus of the prior art systems is purpose-built for grain aeration. However, a typical farm includes many other systems and equipment beyond grain storage bins, such as augers, grain legs, and lighting. Each of these systems would require its own separate control apparatus, increasing cost and complexity. There is no provision in the prior art for a modular design that would allow a common base unit to be adapted for controlling different farm equipment through interchangeable components.

Fourth, in the event that a grain temperature sensor and/or static pressure sensor is desired to provide signals indicative of the temperature of the grain within the storage bin, establishing a wired connection between the controller and the sensor(s) can be suboptimal in terms of time and cost. Storage bins are not all identical, so each wired connection becomes a custom installation. That increases cost, as does the cost of the wiring itself. The wiring cost is magnified when a single controller controls multiple storage bins, each having its own sensor(s). Similarly, the wired connection between the controller and the aeration fan presents installation challenges.

### SUMMARY

The present disclosure addresses the problems described in the Background, in a variety of ways. With respect to the first problem (aeration fan as a chokepoint), the disclosure provides a current sensor operably connected to the aeration fan and a controller configured to determine whether the aeration fan has become inoperable or is operating suboptimally and to cause a notification to be issued to the operator. With respect to the second problem (operator must be physically present at the control box), the disclosure provides a controller configured to wirelessly communicate with a mobile electronic device without requiring a central computer intermediary, to accept input from the mobile electronic device as a duplicate of the human-machine interface, and to push notifications regarding system status so that the operator can receive information and issue commands without being physically present at the storage bin. With respect to the third problem (control apparatus is purpose-built for grain aeration), the disclosure provides a modular peripheral unit design with a base unit and interchangeable daughter boards that allows a common base unit to be adapted for controlling different farm equipment including aeration fans, augers, grain legs, and lighting. With respect to the fourth problem (wired connections for sensors), the disclosure provides wireless communication between the controller and the peripheral units, avoiding the need for custom wiring installations for grain temperature sensors, static pressure sensors, and other sensors within or proximate the storage bin.

According to a first aspect of the present disclosure, a system for controlling farm operations is provided, the system comprising: a controller configured to activate an aeration fan for aeration of grain stored in a storage bin, the controller comprising a wireless transmitter and a wireless receiver; and at least one peripheral unit in communication with the controller, each of the at least one peripheral units comprising a base unit and an interchangeable daughter board, the base unit comprising a microcontroller, a printed circuit board, a power source, a wireless transmitter, and a wireless receiver, the daughter board in this instance being a fan control board comprising a relay configured to control activation of the aeration fan, wherein the controller is configured to cause the wireless transmitter of the controller to transmit a command to the wireless receiver of the base unit to activate or deactivate the aeration fan, and wherein the microcontroller of the base unit is configured to receive the command and cause the fan control board to control activation of the aeration fan in accordance with the command; and optionally one or more additional peripheral units having daughter boards selected from: (i) an ambient temperature and humidity sensor board, (ii) a fan sensor board configured to monitor current drawn by the aeration fan, (iii) an auger control board configured to control, and optionally monitor, an electric motor of an auger, (iv) a grain leg control board configured to control, and optionally monitor, an electric motor of a grain leg, (v) a lighting control board configured to control lights proximate the storage bin, (vi) a grain temperature sensor board, (vii) a static pressure sensor board, (viii) a weight sensor board, (ix) a vent pressure sensor board, (x) a rotation sensor board, (xi) a CO₂ sensor board, (xii) a volatile organic compound (VOC) sensor board, (xiii) a vibration sensor board, (xiv) a time-of-flight (ToF) sensor, and (xv) an infrared sensor.

According to a second aspect of the present disclosure, the system of the first aspect is presented, wherein the power source of the base unit comprises a battery pack capable of solar recharge or a 120V input.

According to a third aspect of the present disclosure, the system of any one of the first through second aspects is presented, wherein the peripheral unit comprises a unique address for identification by the controller.

According to a fourth aspect of the present disclosure, the system of any one of the first through third aspects is presented, further comprising: a plurality of peripheral units, each peripheral unit having a different daughter board configured to provide different functionality.

According to a fifth aspect of the present disclosure, the system of any one of the first through fourth aspects is presented, wherein the controller is further configured to communicate with a mobile electronic device and to accept input from the mobile electronic device to control functionality provided by the daughter board of the peripheral unit.

According to a sixth aspect of the present disclosure, the system of the fifth aspect is presented, wherein the controller is further configured to push a notification to the mobile electronic device regarding a status of the functionality provided by the daughter board of the peripheral unit.

According to a seventh aspect of the present disclosure, the system of any one of the fifth through sixth aspects is presented, wherein the daughter board is the fan sensor board, wherein the fan sensor board comprises a current sensor configured to be operably connected to the aeration fan and to output a signal that changes as a function of current that the aeration fan draws, and wherein the microcontroller of the base unit is configured to receive the signal from the current sensor and cause the wireless transmitter to transmit data corresponding to the signal to the wireless receiver of the controller, and wherein the controller is further configured to determine the current drawn by the aeration fan as a function of the signal from the current sensor and to push a notification to the mobile electronic device when the current is outside a predetermined range.

According to an eighth aspect of the present disclosure, the system of any one of the fifth through sixth aspects is presented, wherein the daughter board is the auger control board, wherein the auger control board comprises a relay configured to control activation of an electric motor of an auger for a grain unloading system, and wherein the controller is further configured to receive a command from the mobile electronic device to activate or deactivate the electric motor and to cause the wireless transmitter of the controller to transmit the command to the wireless receiver of the base unit, and wherein the microcontroller of the base unit is configured to receive the command and cause the auger control board to control activation of the electric motor in accordance with the command.

According to a ninth aspect of the present disclosure, the system of any one of the fifth through sixth aspects is presented, wherein the daughter board is the grain leg control board, wherein the grain leg control board comprises a relay configured to control activation of an electric motor of a grain leg, and wherein the controller is further configured to receive a command from the mobile electronic device to activate or deactivate the electric motor and to cause the wireless transmitter of the controller to transmit the command to the wireless receiver of the base unit, and wherein the microcontroller of the base unit is configured to receive the command and cause the grain leg control board to control activation of the electric motor in accordance with the command.

According to a tenth aspect of the present disclosure, the system of any one of the fifth through sixth aspects is presented, wherein the daughter board is the lighting control board, wherein the lighting control board comprises a relay configured to control activation of lights proximate the storage bin, and wherein the controller is further configured to receive a command from the mobile electronic device to activate or deactivate the lights and to cause the wireless transmitter of the controller to transmit the command to the wireless receiver of the base unit, and wherein the microcontroller of the base unit is configured to receive the command and cause the lighting control board to control activation of the lights in accordance with the command.

According to an eleventh aspect of the present disclosure, the system of any one of the fifth through sixth aspects is presented, wherein the daughter board is the grain temperature sensor board, the grain temperature sensor board configured to receive a signal from a temperature probe, the temperature probe configured to be disposed within the storage bin and in contact with the grain and to output a signal that changes as a function of grain temperature, wherein the microcontroller of the base unit is configured to receive the signal from the temperature probe and cause the wireless transmitter to transmit data corresponding to the signal to the wireless receiver of the controller, and wherein the controller is further configured to determine the grain temperature as a function of the signal from the temperature probe and to push a notification to the mobile electronic device regarding the grain temperature.

According to a twelfth aspect of the present disclosure, the system of any one of the fifth through sixth aspects is presented, wherein the daughter board is the static pressure sensor board, the static pressure sensor board configured to receive a signal from a static pressure sensor, the static pressure sensor configured to be disposed in an airflow path between the aeration fan and the grain and to output a signal that changes as a function of static pressure, wherein the microcontroller of the base unit is configured to receive the signal from the static pressure sensor and cause the wireless transmitter to transmit data corresponding to the signal to the wireless receiver of the controller, and wherein the controller is further configured to determine the static pressure as a function of the signal from the static pressure sensor and to push a notification to the mobile electronic device regarding the static pressure.

According to a thirteenth aspect of the present disclosure, the system of any one of the fifth through sixth aspects is presented, wherein the daughter board is the weight sensor board, the weight sensor board configured to receive a signal from a weight sensor, the weight sensor configured to measure weight of grain to be added to the storage bin, wherein the microcontroller of the base unit is configured to receive the signal from the weight sensor and cause the wireless transmitter to transmit data corresponding to the signal to the wireless receiver of the controller, and wherein the controller is further configured to determine a combined weight of the grain from successive loads as a function of the signal from the weight sensor and to push a notification to the mobile electronic device when a predetermined percentage of a total capacity of the storage bin has been occupied by the grain.

According to a fourteenth aspect of the present disclosure, the system of any one of the fifth through sixth aspects is presented, further comprising: a first peripheral unit having a vent pressure sensor board as the daughter board, the vent pressure sensor board configured to receive a signal from a pressure sensor disposed proximate a vent of the storage bin; and a second peripheral unit having a static pressure sensor board as the daughter board, the static pressure sensor board configured to receive a signal from a static pressure sensor disposed in an airflow path between the aeration fan and a plenum below a floor with perforations that support the grain in the storage bin; wherein the controller is further configured to determine whether the plenum is clogged as a function of the signals from the pressure sensor and the static pressure sensor and to push a notification to the mobile electronic device when the plenum is determined to be clogged.

According to a fifteenth aspect of the present disclosure, the system of any one of the fifth through sixth aspects is presented, wherein the daughter board is the rotation sensor board, the rotation sensor board configured to receive a signal from a rotation sensor, the rotation sensor configured to be associated with the aeration fan and to output a signal that changes as a function of whether blades of the aeration fan are rotating, wherein the microcontroller of the base unit is configured to receive the signal from the rotation sensor and cause the wireless transmitter to transmit data corresponding to the signal to the wireless receiver of the controller, and wherein the controller is further configured to determine whether the blades of the aeration fan are rotating as a function of the signal from the rotation sensor and to push a notification to the mobile electronic device when the blades are not rotating.

According to a sixteenth aspect of the present disclosure, the system of any one of the first through fourth aspects is presented, wherein the daughter board is the ambient temperature and humidity sensor board, the ambient temperature and humidity sensor board comprising a temperature sensor configured to output a signal that changes as a function of ambient air temperature and a humidity sensor configured to output a signal that changes as a function of ambient air relative humidity, wherein the microcontroller of the base unit is configured to receive the signals from the temperature sensor and the humidity sensor and cause the wireless transmitter to transmit data corresponding to the signals to the wireless receiver of the controller, and wherein the controller is further configured (i) to determine and store a current ambient air temperature as a function of the signal from the temperature sensor, (ii) to determine and store a running average ambient air temperature from the current ambient air temperature as a function of time, (iii) to compare a current ambient air temperature to the running average ambient air temperature, (iv) to determine an equilibrium moisture content (EMC) corresponding to a type of grain stored as a function of the signals from the temperature sensor and the humidity sensor, (v) to compare the EMC to a desired grain moisture content, and (vi) to activate the aeration fan when the current ambient air temperature is within a predetermined acceptable range from the running average ambient air temperature and the EMC is within a predetermined acceptable range from the desired grain moisture content.

According to a seventeenth aspect of the present disclosure, the system of the sixteenth aspect is presented, wherein the controller is further configured to communicate with a mobile electronic device and to push a notification to the mobile electronic device regarding the EMC.

According to an eighteenth aspect of the present disclosure, the system of any one of the first through seventeenth aspects or the sixteenth aspect is presented, wherein the controller is further configured to receive data from a temperature sensor and a humidity sensor of one or more other systems to determine whether a weather front is advancing toward the storage bin and to activate the aeration fan as a consequence.

According to a nineteenth aspect of the present disclosure, a system for controlling aeration of grain stored in a storage bin is provided, the system comprising: a current sensor configured to be operably connected to an aeration fan and to output a signal that changes as a function of current that the aeration fan draws; a human-machine interface; and a controller in communication with the current sensor and the human-machine interface, the controller configured (i) to activate the aeration fan, (ii) to determine the current that the aeration fan is drawing when activated as a function of the signal from the current sensor, and (iii) to cause the human-machine interface to issue a notification to a user when the current that the aeration fan is drawing is outside a predetermined range.

According to a twentieth aspect of the present disclosure, the system of the nineteenth aspect is presented, further comprising: a temperature sensor configured to output a signal that changes as a function of ambient air temperature; a humidity sensor configured to output a signal that changes as a function of ambient air relative humidity; wherein the controller is in communication with the temperature sensor and the humidity sensor and is further configured: (i) to determine and store a current ambient air temperature as a function of the signal from the temperature sensor, (ii) to determine and store a running average ambient air temperature from the current ambient air temperature as a function of time, (iii) to compare a current ambient air temperature to the running average ambient air temperature, (iv) to determine an equilibrium moisture content (EMC) corresponding to a type of grain stored as a function of the signals from the temperature sensor and the humidity sensor, (v) to compare the EMC to a desired grain moisture content, and (vi) to activate the aeration fan when the current ambient air temperature is within a predetermined acceptable range from the running average ambient air temperature and the EMC is within a predetermined acceptable range from the desired grain moisture content.

According to a twenty-first aspect of the present disclosure, the system of any one of the nineteenth through twentieth aspects is presented, wherein the current sensor is a shunt-based or Hall-effect sensor.

According to a twenty-second aspect of the present disclosure, the system of any one of the nineteenth through twenty-first aspects is presented, further comprising a peripheral unit with a wireless transmitter configured to transmit data corresponding to the signal from the current sensor to the controller, and wherein the controller comprises a receiver configured to receive the data from the wireless transmitter of the peripheral unit.

According to a twenty-third aspect of the present disclosure, the system of the twenty-second aspect is presented, wherein the wireless transmitter is configured to transmit the signal via WiFi, radio frequency (RF), or LoRa.

According to a twenty-fourth aspect of the present disclosure, the system of any one of the nineteenth through twenty-third aspects is presented, wherein the current that the aeration fan is drawing comprises an inrush current that the aeration fan is drawing upon activation.

According to a twenty-fifth aspect of the present disclosure, the system of the twenty-fourth aspect is presented, wherein the predetermined value for the current of the aeration fan is the rated current of the aeration fan, and the notification to the user that the controller is configured to cause the human-machine interface to issue is that the aeration fan has not started properly.

According to a twenty-sixth aspect of the present disclosure, the system of any one of the nineteenth through twenty-fifth aspects is presented, wherein the current that the aeration fan is drawing comprises an operating current that the aeration fan is drawing at steady state after activation.

According to a twenty-seventh aspect of the present disclosure, the system of the twenty-sixth aspect is presented, wherein the controller is configured to cause the notification issued to the user to convey that the aeration fan is operating suboptimally.

According to a twenty-eighth aspect of the present disclosure, the system of any one of the nineteenth through twenty-seventh aspects is presented, wherein the controller is further configured to communicate with a mobile electronic device, to accept input from the mobile electronic device as a duplicate of the human-machine interface, and to cause the mobile electronic device to issue the notification.

According to a twenty-ninth aspect of the present disclosure, the system of any one of the nineteenth through twenty-eighth aspects is presented, wherein the controller is further configured, upon activating the aeration fan, to cause the human-machine interface to issue a notification to the user that the aeration fan is activated.

According to a thirtieth aspect of the present disclosure, a system for controlling aeration of grain stored in a storage bin is provided, the system comprising: a human-machine interface; a controller in direct communication with the human-machine interface, the controller configured (i) to activate an aeration fan, (ii) to wirelessly communicate with a mobile electronic device without requiring a central computer intermediary, (iii) to accept input from the mobile electronic device as a duplicate of the human-machine interface, and (iv) to push a notification to the mobile electronic device regarding a status of the aeration fan.

According to a thirty-first aspect of the present disclosure, the system of the thirtieth aspect is presented, further comprising: a temperature sensor configured to output a signal that changes as a function of ambient air temperature; and a humidity sensor configured to output a signal that changes as a function of ambient air relative humidity; wherein the controller is in communication with the temperature sensor and the humidity sensor.

According to a thirty-second aspect of the present disclosure, the system of the thirty-first aspect is presented, wherein the controller is further configured to push a notification to the mobile electronic device regarding the ambient air temperature or the ambient air relative humidity.

According to a thirty-third aspect of the present disclosure, the system of any one of the thirty-first through thirty-second aspects is presented, wherein the controller is further configured (i) to determine and store a current ambient air temperature as a function of the signal from the temperature sensor, (ii) to determine and store a running average ambient air temperature from the current ambient air temperature as a function of time, (iii) to compare a current ambient air temperature to the running average ambient air temperature, (iv) to determine an equilibrium moisture content (EMC) corresponding to a type of grain stored as a function of the signals from the temperature sensor and the humidity sensor, (v) to compare the EMC to a desired grain moisture content, (vi) to activate the aeration fan when the current ambient air temperature is within a predetermined acceptable range from the running average ambient air temperature and the EMC is within a predetermined acceptable range from the desired grain moisture content, and (vii) to push a notification to the mobile electronic device regarding the EMC.

According to a thirty-fourth aspect of the present disclosure, the system of any one of the thirtieth through thirty-third aspects is presented, wherein the input accepted from the mobile electronic device includes one or more of grain type, desired grain moisture content, desired time of daily fan operation, or a command to activate or deactivate the aeration fan.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

In the Drawings:

FIG. 1 provides a detailed schematic diagram of a system for controlling farm operations, illustrating the controller with its wireless transmitter and wireless receiver, a plurality of peripheral units each comprising a base unit with a microcontroller, printed circuit board, power source, wireless transmitter, and wireless receiver, and various interchangeable daughter boards including an ambient temperature and humidity sensor board, a fan control board, a fan sensor board, an auger control board, a grain leg control board, a lighting control board, a grain temperature sensor board, a static pressure sensor board, a weight sensor board, a vent pressure sensor board, a rotation sensor board, and a CO₂ sensor board, along with a human-machine interface comprising a visual display and an input key panel, and a mobile electronic device configured to receive notifications from the controller, according to aspects of the present disclosure;

FIG. 2 shows a comprehensive schematic view of the system for controlling farm operations in an operational configuration, depicting a storage bin with a side wall, a roof with a vent, a floor with perforations supporting grain thereabove, a plenum below the floor through which airflow is conducted, a conduit connecting an aeration fan to the plenum, the aeration fan drawing air from an ambient environment, debris accumulated within the plenum, and the distribution of peripheral units throughout the system including the controller, the human-machine interface, the mobile electronic device, and various daughter boards with their associated sensors and controlled equipment including an auger with an electric motor, a grain leg with an electric motor, lights, a temperature probe disposed within the storage bin and in contact with the grain, a static pressure sensor, a weight sensor, a pressure sensor proximate the vent, a rotation sensor associated with the aeration fan, and a CO₂ sensor proximate the vent, according to an embodiment;

FIG. 3 illustrates a block diagram of a peripheral unit of the system for controlling farm operations, showing the structural relationship between the base unit and the interchangeable daughter board, wherein the base unit includes a microcontroller, a printed circuit board providing the physical substrate upon which components are mounted, a power source supplying electrical power to the components, a wireless transmitter for transmitting data to the controller, and a wireless receiver for receiving commands from the controller, and wherein the daughter board is connected to the base unit and is interchangeable to allow the peripheral unit to be adapted for different farm operations, according to aspects of the present disclosure;

FIG. 4A depicts a plan view of a mobile electronic device operating as a second human-machine interface to control and communicate with the controller, illustrating a dashboard display showing a notification indicating a fan start error along with current temperature and humidity readings with timestamps, according to an embodiment;

FIG. 4B depicts a plan view of the mobile electronic device of FIG. 4A, illustrating a display for a storage bin designated with a grain type, showing a notification indicating fan activation, a target moisture content, a daily runtime, and a graph showing runtime and backlog data, according to aspects of the present disclosure; and

FIG. 4C depicts a plan view of the mobile electronic device of FIG. 4A, illustrating a display with a notification indicating that the aeration fan requires service, along with information panels showing operational parameters including grain type, backlog hours, target moisture content, daily runtime, and selectable data viewing options, according to an embodiment.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

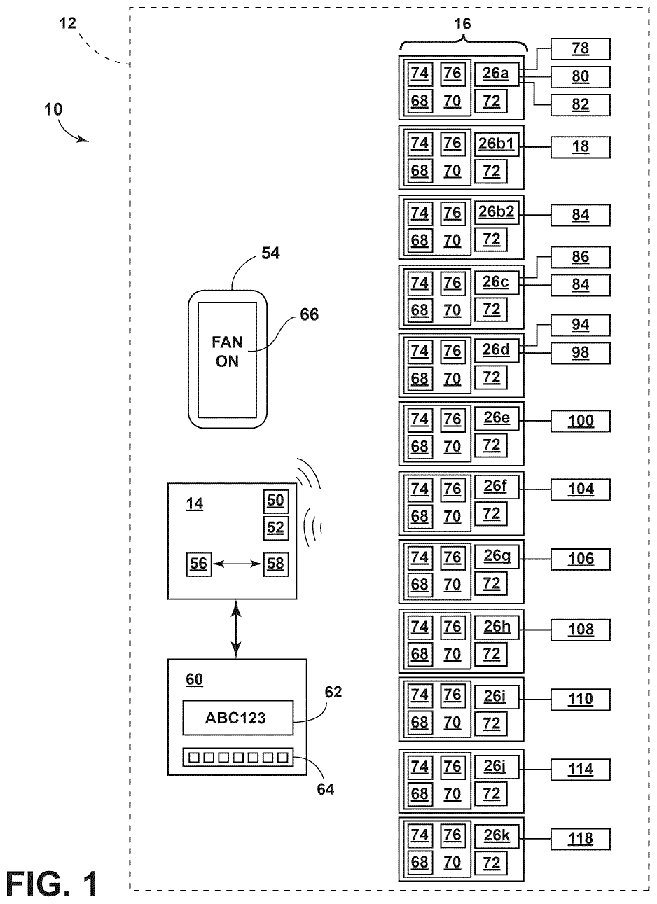

Referring to FIG. 1, a system 10 for controlling farm operations 12 is herein described. The system 10 includes a controller 14 and one or more peripheral units 16. The controller 14 is configured to activate an aeration fan 18 for aeration of grain 20 stored in a storage bin 22, the aeration of grain 20 being one of one or more farm operations 12 that the system controls. As will be further discussed, the peripheral units 16 provide modularity to the system 10, allowing a common base unit 24 to be adapted for different farm operations 12 through interchangeable daughter boards 26.

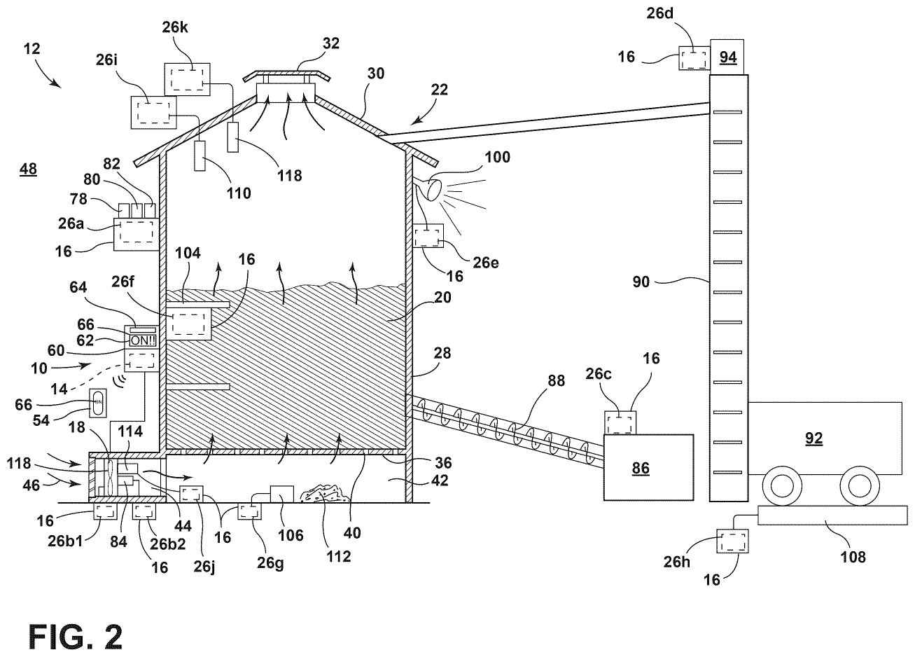

Referring now to FIG. 2, the particular form that the storage bin 22 takes is not particularly important. As an example, the storage bin 22 can include a side wall 28, which may be upright and cylindrical. The storage bin 22 can further include a roof 30 above the side wall 28 with a vent 32 for airflow 34 providing the aeration. The storage bin 22 can further include a floor 36 that is raised and has perforations 40 to support the grain 20 thereabove but permits the airflow 34 therethrough along an airflow 34 path for the aeration of the grain 20. Below the floor 36 can be a plenum 42 through which the airflow 34 is conducted to the perforations 40. An aeration fan 18, which may be disposed in a conduit 44 preceding the plenum 42, moves air 46 from an ambient environment 48 (e.g., external environment) into the conduit 44 and thereafter the plenum 42. The particular kind of grain 20 held within the storage bin 22 is not particularly important, but may include one or more of barley, canola, yellow corn, cottonseed, red edible beans, tall fescue, garbanzo beans, oats, peanuts, pinto beans, popcorn, brown rice, rough rice, sorghum/milo, soybeans, sunflowers, durum wheat, hard red wheat, and soft wheat.

The controller 14 includes a wireless transmitter 50 and a wireless receiver 52. The wireless transmitter 50 and the wireless receiver 52 can be combined as a single wireless transceiver unit. The wireless transmitter 50 and the wireless receiver 52 provide communication to, from, and between the controller 14 and the one or more peripheral units 16. In addition, the wireless transmitter 50 and the wireless receiver 52 provide communication to, from, and between the controller 14 and a mobile electronic device 54. The wireless transmitter 50 is configured to transmit commands and data to the peripheral units 16 and to the mobile electronic device 54. The wireless receiver 52 is configured to receive signals and data from the peripheral units 16 and the mobile electronic device 54. The wireless communication may be via WiFi, radio frequency (RF), LoRa, cellular modem, or other suitable wireless protocols. LoRa may be particularly useful when the peripheral units 16 are separated from the controller 14 by relatively large distances. The controller 14 further includes memory 56 and a processor 58. The memory 56 can include programs stored therein that the processor 58 executes to effectuate the performance of the system 10 described herein.

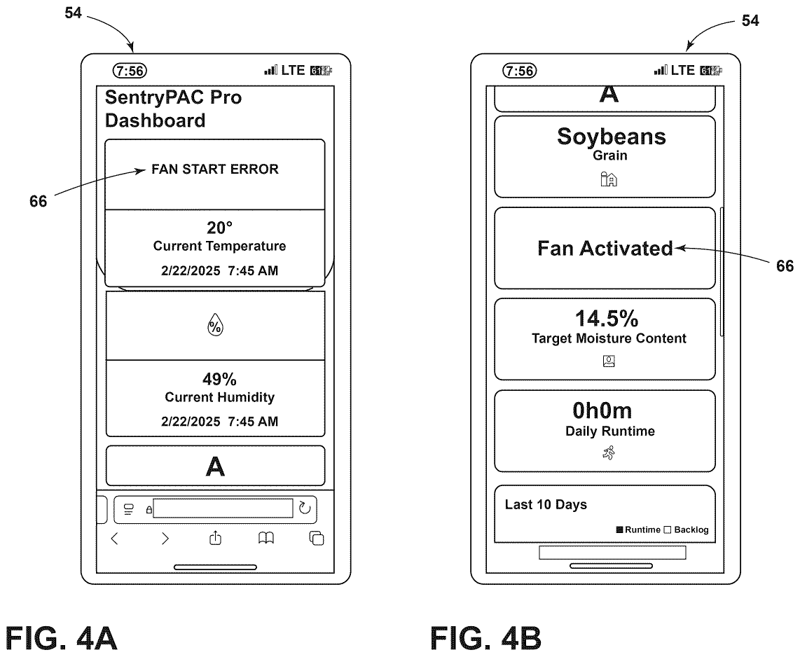

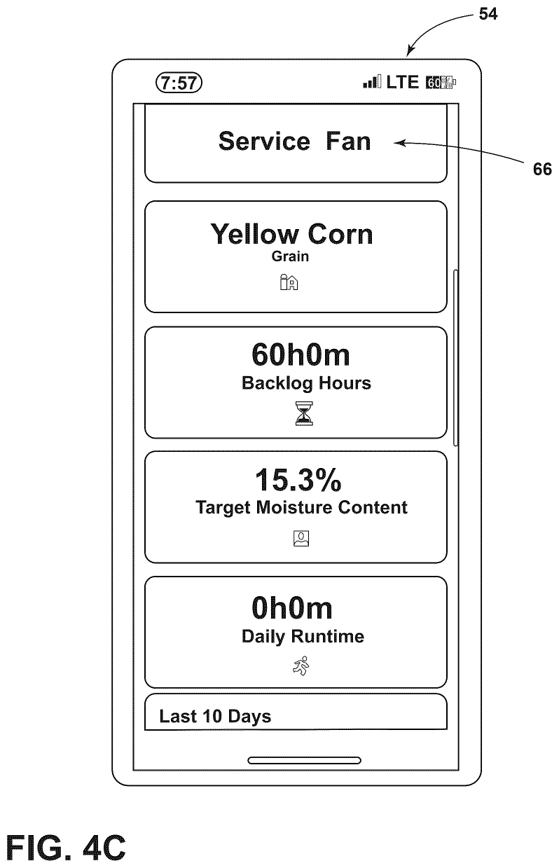

The system 10 can further include a human-machine interface 60. The human-machine interface 60 is in direct communication with the controller 14. The human-machine interface 60 may include a visual display 62 and an input key panel 64 for operator/user input of controller 14 and system 10 functions. At the human-machine interface 60, the operator can input and thereby inform the controller 14 of the type of grain 20 held within the storage bin 22, a desired grain 20 moisture content, a desired time of daily fan operation, and any other input necessary for the system 10 to function as described herein. The controller 14 can cause the human-machine interface 60 to issue notifications 66 (see FIGS. 4A-4C) to the operator regarding system status, including notifications 66 regarding the status of the aeration fan 18.

The controller 14 is further configured to wirelessly communicate with the mobile electronic device 54 without requiring a central computer intermediary. The mobile electronic device 54 can be a smart phone, a tablet, or the like. Via appropriate software stored in memory of the controller 14, and compatible software stored in memory of the mobile electronic device 54 or otherwise available thereto (e.g., an application or “app”), the operator can provide inputs to the controller 14 via the mobile electronic device 54 as a duplicate of the human-machine interface 60. The input accepted from the mobile electronic device 54 may include one or more of grain type, desired grain moisture content, desired time of daily fan operation, or a command to activate or deactivate the aeration fan 18. The mobile electronic device 54 can be in communication with the controller 14 via WiFi for shorter range communications and through a network (e.g., cellular, Internet, and so on) with or without a cloud intermediary for longer range communications.

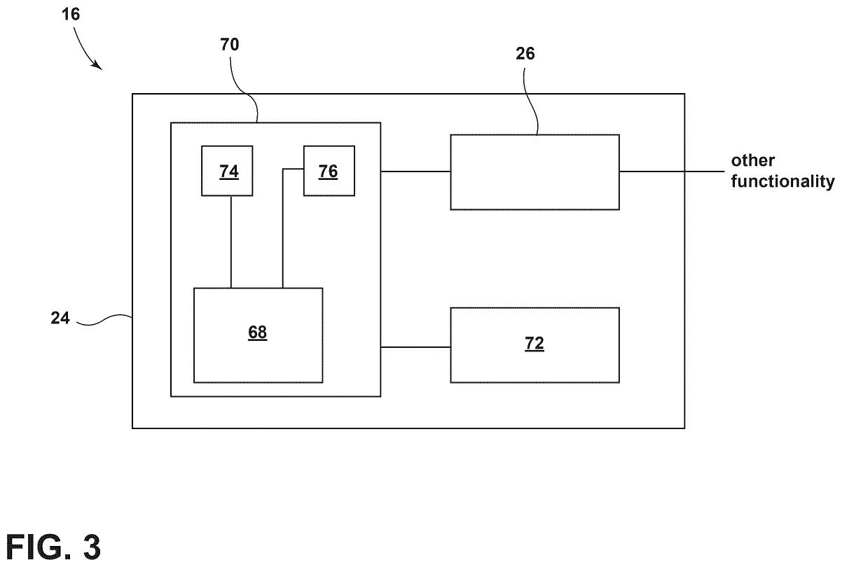

As mentioned, the system 10 includes one or more peripheral units 16 in communication with the controller 14. Referring now to FIG. 3, each peripheral unit 16 has the base unit 24 and the interchangeable daughter board 26. The base unit 24 includes a microcontroller 68, a printed circuit board 70, a power source 72, a wireless transmitter 74, and a wireless receiver 76. The daughter board 26 is configured to provide functionality specific to a selected application.

The microcontroller 68 of the base unit 24 is configured to receive signals from sensors or other components on or connected to the daughter board 26, process those signals, and cause the wireless transmitter 74 to transmit data corresponding to the signals to the wireless receiver 52 of the controller 14. The microcontroller 68 is also configured to receive commands from the controller 14 via the wireless receiver 76 and cause the daughter board 26 to perform actions in accordance with those commands.

The power source 72 of the base unit 24 may include a battery pack capable of solar recharge or a 120V input. Solar recharge may be particularly useful for peripheral units 16 located in remote areas of the farm where access to electrical power is limited. All wireless sensors disclosed herein could be powered via solar cells or battery.

Each peripheral unit 16 may include a unique address for identification by the controller 14. The unique address allows the controller 14 to distinguish between signals received from different peripheral units 16, which is particularly useful when the system 10 includes a plurality of peripheral units 16, each peripheral unit 16 having a different daughter board 26 configured to provide different functionality. The wireless transmitter 74 of the base unit 24 may be configured to transmit data via WiFi, radio frequency (RF), or LoRa. LoRa may be particularly useful when the peripheral unit 16 is separated from the controller 14 by a relatively large distance.

The controller 14 is further configured to communicate with the mobile electronic device 54 and to accept input from the mobile electronic device 54 to control functionality provided by the daughter board 26 of the peripheral unit 16. Likewise, the controller 14 is further configured to push a notification 66 to the mobile electronic device 54 regarding a status of the functionality provided by the daughter board 26 of the peripheral unit 16. These aspects will be exemplified below.

The interchangeable daughter board 26 may be one of the following:

### (i) Ambient Temperature and Humidity Sensor Board

The daughter board 26 may be an ambient temperature and humidity sensor board 26a. The ambient temperature and humidity sensor board includes a temperature sensor 78 configured to output a signal (e.g., voltage, resistance, expansion, and so on) that changes as a function of ambient air temperature. As the ambient air temperature changes, so does the signal that the temperature sensor 78 outputs. The temperature sensor may be a thermocouple, a thermistor, a semiconductor integrated circuit sensor, among other options. The ambient temperature and humidity sensor board further includes a humidity sensor 80 configured to output a signal that changes as a function of ambient air relative humidity. As the ambient air relative humidity changes, so does the signal that the humidity sensor 80 outputs. The humidity sensor 80 may be a capacitive humidity sensor, a resistive humidity sensor, a thermal conductivity humidity sensor, among other options. In some embodiments, the temperature sensor 78 and the humidity sensor 80 may be integrated into a single sensor unit. The ambient temperature and humidity sensor board 26a may further include a barometric sensor 82 that can provide additional useful data for the controller 14.

The microcontroller 68 of the base unit 24 is configured to receive the signals from the temperature sensor 78 and the humidity sensor 80 and cause the wireless transmitter 74 to transmit data corresponding to the signals to the wireless receiver 52 of the controller 14. The receiver 52 of the controller 14 would match whatever protocol the wireless transmitter 74 is utilizing.

The controller 14 is configured to determine and store a current ambient air temperature as a function of the signal from the temperature sensor 78. In embodiments, the controller 14 is configured to determine and store the current ambient air temperature upon every expiration of a predetermined interval within a range of from 10 minutes to 30 minutes. The controller 14 is further configured to determine and store a running average ambient air temperature from the current ambient air temperature as a function of time. In embodiments, the running average ambient air temperature that the controller 14 is configured to determine and store is over a predetermined interval within a range of from 14 days to 35 days.

The controller 14 is further configured to compare a current ambient air temperature to the running average ambient air temperature. The controller 14 is further configured to determine an equilibrium moisture content (EMC) corresponding to a type of grain 20 stored as a function of the signals from the temperature sensor 78 and the humidity sensor 80. In embodiments, the controller 14 determines the EMC from a stored lookup table or equation. EMC is determined from such tables or equations from known ambient air temperature and ambient air humidity values. If the operator desires to maintain the moisture content of the grain 20 as when storage was initiated, then the grain 20 should be aerated when the determined EMC is equal to the moisture content of the grain 20. If the operator desires to dry the grain 20, then the EMC should be less than the moisture content of the grain 20. If the operator desires to rewet the grain 20, then the EMC should be greater than the moisture content of the grain 20. The controller 14 is further configured to compare the EMC to a desired grain 20 moisture content. The desired grain 20 moisture content can be operator inputted at the human-machine interface 60 or the mobile electronic device 54, and in embodiments may be assumed to be the initial grain 20 moisture content inputted.

The controller 14 is further configured to activate the aeration fan 18 when the current ambient air temperature is within a predetermined acceptable range from the running average ambient air temperature and the EMC is within a predetermined acceptable range from the desired grain 20 moisture content. The controller 14 would do so to maintain the moisture content of the grain 20. In embodiments, the predetermined acceptable range for the comparison of the current ambient air temperature and the running average ambient air temperature is ±5 degrees Fahrenheit or narrower (e.g., ±1 degree). In embodiments, the predetermined acceptable range for the comparison of the EMC to the desired grain 20 moisture content is ±5 percent or narrower (e.g., ±1 percent).

In embodiments, the controller 14 is configured to determine upon initial loading of the grain 20 if special circumstances warrant a departure from aeration to gradually equilibrate grain 20 conditions with ambient conditions. After harvest of the grain 20, the moisture content and temperature of every truck load of the grain 20 is determined before loading into the storage bin 22. The operator can enter the moisture content and temperature values into the human-machine interface 60 or the mobile electronic device 54. The controller 14 accepts the entries and can determine, as a function of the initial moisture and temperature of the grain 20, an initial approach in aerating the grain 20. For example, if the grain 20 is determined to have a moisture content of 17.5% and a temperature of 76 degrees, then the controller 14 may recommend and implement a fall cooldown for 1 week and then switch to a storage mode with an airflow of 3.5 hours per day. The fall cooldown and storage mode parameters can be found in the patents incorporated herein by reference.

The controller 14 activates the aeration fan 18 by transmitting a command via the wireless transmitter 50 to the peripheral unit 16 configured to control the aeration fan 18. In other embodiments, the controller 14 may be directly wired to the aeration fan 18 or to a relay that controls the aeration fan 18.

The controller 14 is further configured to push a notification 66 to the mobile electronic device 54 regarding the ambient air temperature, the ambient air relative humidity, and/or the EMC. The controller 14 is further configured to push notifications 66 to the mobile electronic device 54 regarding a status of the aeration fan 18 and other system 10 parameters. For example, the controller 14 may be further configured, upon activating the aeration fan 18, to cause the human-machine interface 60 to issue a notification 66 to the user that the aeration fan 18 is activated (e.g., “FAN ACTIVATED” or “ON”, an image of a fan with blades circulating, or anything else that conveys the information). This notification 66 may also be pushed to the mobile electronic device 54. The mobile electronic device 54 is an operable duplicate of the human-machine interface 60.

### (ii) Fan Control Board

In embodiments, the daughter board 26 is a fan control board 26b1. The fan control board 26b1 is configured to control activation of the aeration fan 18. The fan control board 26b1 comprises a relay configured to control activation of the aeration fan 18. The controller 14 is configured to cause the wireless transmitter 50 of the controller 14 to transmit a command to the wireless receiver 76 of the base unit 24 to activate or deactivate the aeration fan 18. The microcontroller 68 of the base unit 24 is configured to receive the command and cause the fan control board 26b1 to control activation of the aeration fan 18 in accordance with the command. In embodiments where the controller 14 is directly wired to the aeration fan 18 or to a relay that controls the aeration fan 18, the fan control board 26b1 is not required. The controller 14 may also be configured to receive a command from the mobile electronic device 54 to activate or deactivate the aeration fan 18 and to cause the wireless transmitter 50 of the controller 14 to transmit the command to the wireless receiver 76 of the base unit 24. The microcontroller 68 of the base unit 24 is configured to receive the command and cause the fan control board 26b1 to control activation of the aeration fan 18 in accordance with the command.

### (iii) Fan Sensor Board

In embodiments, the daughter board 26 is a fan sensor board 26b2. The fan sensor board 26b2 is configured to monitor the current drawn by the aeration fan 18. The fan sensor board 26b2 comprises a current sensor 84. The current sensor 84 is operably connected to the aeration fan 18 and outputs a signal that changes as a function of current that the aeration fan 18 draws. The current sensor 84 may be a shunt-based sensor or a Hall-effect sensor. Preferably, the current sensor 84 is an inline current sensor (e.g., a shunt-based resistor or a Hall-effect sensor) that is spliced into the electronic circuitry of the aeration fan 18, so that voltage drop across a resistor can be determined and the current calculated therefrom (current equals voltage over resistance).

The microcontroller 68 of the base unit 24 is configured to receive the signal from the current sensor 84 and cause the wireless transmitter 74 to transmit data corresponding to the signal to the wireless receiver 52 of the controller 14. In turn, the controller 14 is configured to determine the current that the aeration fan 18 is drawing when activated as a function of the signal from the current sensor 84. Alternatively, the microcontroller 68 of the base unit 24 may make the determination directly, and that value is transmitted to the controller 14 and accepted as input of the current. The controller 14 is further configured to cause the human-machine interface 60 to issue a notification 66 to a user when the current that the aeration fan 18 is drawing is outside a predetermined range. Likewise, the controller 14 may be further configured to push a notification 66 to the mobile electronic device 54 when the current is outside a predetermined range.

In embodiments, the current that the aeration fan 18 is drawing is an inrush current that the aeration fan 18 is drawing upon activation. The inrush current is the initial surge of current when the aeration fan 18 motor starts. The aeration fan 18 typically has a rated current, which is the current at which the aeration fan 18 is engineered to draw when activated. The rated current is typically noted on a service panel or elsewhere of the aeration fan 18. The human-machine interface 60 or the mobile electronic device 54 can ask the operator to input the rated current upon setup. In some instances, such as when the aeration fan 18 does not have a soft-start feature, the current that the aeration fan 18 draws upon startup surges to several times the rated current. If the values for current that the controller 14 receives upon activation of the aeration fan 18 are less than the rated current, then it may be assumed that the aeration fan 18 is not starting up properly. In such embodiments, the predetermined value for the current of the aeration fan 18 may be the rated current of the aeration fan 18, and the notification 66 to the user that the controller 14 is configured to push to the mobile electronic device 54 and/or cause the human-machine interface 60 to issue is that the aeration fan 18 has not started properly (e.g., “FAN START ERROR”).

In embodiments, the current that the aeration fan 18 is drawing is an operating current that the aeration fan 18 is drawing at steady state after activation. If the values for current that the controller 14 receives after activation and during steady state (e.g., after 15 seconds from startup) are less than the rated current, then it may be assumed that the aeration fan 18 is not operating properly. In such embodiments, the controller 14 is configured to cause the notification 66 issued or pushed to the user to convey that the aeration fan 18 is operating suboptimally (e.g., “SERVICE FAN”). A decrease in operating current at steady state may indicate that the aeration fan 18 blades are dirty or damaged, that the motor bearings are worn, or that there is some other issue affecting the performance of the aeration fan 18. The controller 14 can be further configured to learn the current-as-a-function-of-time behavior of the aeration fan 18 and to identify deviations from the learned behavior. Upon identifying a deviation, the controller 14 can assume that the aeration fan 18 is beginning to operate suboptimally and may benefit from servicing or replacement. In this manner, the controller 14 can cause the human-machine interface 60 or the mobile electronic device 54 to issue a notification 66 that the aeration fan 18 performance is deteriorating long before the aeration fan 18 becomes a liability for lack of operability.

### (iv) Auger Control Board

The daughter board 26 may be an auger control board 26c configured to control, and optionally monitor, an electric motor 86 of an auger 88. The storage bin 22 is typically associated with an unloading system that utilizes the electric motor 86 to drive the auger 88 that withdraws the grain 20 stored within the storage bin 22. The grain 20 may be delivered to a grain leg 90 and onto a trailer 92. The auger 88 can be part of the farm operations 12 that the system 10 controls. An auger 88 is a screw-like device used to move grain 20, typically to unload grain 20 from a storage bin 22 or to transfer grain 20 from one location to another (such as from a bin 22 to a truck or from a truck to a bin 22). The motor 86 driving the auger 88 is typically activated from a distance. The auger control board 26c includes a relay 94 configured to control activation of the electric motor 86 of the auger 88 for a grain unloading system.

The operator can activate the electric motor 86 via the human-machine interface 60 or the mobile electronic device 54. The electric motor 86 of the auger 88 is typically activated via the start-relay 94. The controller 14 is configured to receive a command from the mobile electronic device 54 to activate or deactivate the electric motor 86 and to cause the wireless transmitter 50 of the controller 14 to transmit the command to the wireless receiver 76 of the base unit 24. The microcontroller 68 of the base unit 24 is configured to receive the command and cause the auger control board 26c to control activation of the electric motor 86 in accordance with the command. Any need to hardwire the controller 14 to the electric motor 86 of the auger 88 is avoided and installation is simplified.

It would be helpful for the operator to know whether the electric motor 86 is operating suboptimally before the electric motor 86 fails. As with the aeration fan 18, in embodiments, the auger control board 26c is further configured to receive a signal from a current sensor 84 operably connected to the electric motor 86 of the auger 88. The controller 14 may be configured to determine the current drawn by the electric motor 86 as a function of the signal from the current sensor 84 and to push a notification 66 to the mobile electronic device 54 when the current is outside a predetermined range, indicating that the electric motor 86 is operating suboptimally (e.g., “SERVICE AUGER MOTOR”). Alternatively, as with the aeration fan 18, two different daughter boards may be used—one for controlling the electric motor 86 (the auger control board 26c) and one for monitoring the current drawn by the electric motor 86 (an auger sensor board).

### (v) Grain Leg Control Board

The daughter board 26 may be a grain leg control board 26d configured to control, and optionally monitor, an electric motor 94 of the grain leg 90. As mentioned, the grain 20 from the auger 88 is delivered to the grain leg 90 before ultimate delivery to the trailer 92. The grain leg 90 can be part of the farm operations 12 that the system 10 controls. A grain leg 90 is a vertical conveyor system used to elevate grain 20 from a lower level to a higher level, typically consisting of a series of buckets attached to a belt or chain that scoops up grain 20 at the bottom and carries it to the top where it is discharged. During use, the electric motor 94 of the grain leg 90 is typically elevated a great distance from the ground (e.g., 100 feet or more). As a consequence, the operability of the electric motor 94 is often never ascertained and rarely serviced. The grain leg control board 26d comprises a relay configured to control activation of the electric motor 94 of the grain leg 90.

The controller 14 is configured to receive a command from the mobile electronic device 54 to activate or deactivate the electric motor 94 and to cause the wireless transmitter 50 of the controller 14 to transmit the command to the wireless receiver 76 of the base unit 24. The microcontroller 68 of the base unit 24 is configured to receive the command and cause the grain leg control board 26d to control activation of the electric motor 94 in accordance with the command.

In embodiments, the grain leg control board 26d is further configured to receive a signal from a current sensor 98 operably connected to the electric motor 94 of the grain leg 90. The controller 14 may be configured to determine the current drawn by the electric motor 94 as a function of the signal from the current sensor 98 and to push a notification 66 to the mobile electronic device 54 when the current is outside a predetermined range, indicating that the electric motor 94 is operating suboptimally (e.g., “SERVICE GRAIN LEG MOTOR”). The controller 14 determines whether the electric motor 94 is operating suboptimally in the same manner as described above for the aeration fan 18. Alternatively, as with the aeration fan 18, two different daughter boards may be used—one for controlling the electric motor 94 (the grain leg control board 26d) and one for monitoring the current drawn by the electric motor 94 (a grain leg sensor board).

### (vi) Lighting Control Board

The daughter board 26 may be a lighting control board 26e configured to control lights 100 proximate the storage bin 22. The lights 100 can be part of the farm operations 12 that the system 10 controls. The storage bin 22 and the environment surrounding the storage bin 22 is sometimes used during the nighttime or during other low natural lighting conditions. As a consequence, the storage bin 22 and the environment is illuminated with lights 100. Activation of the lights 100 is typically achieved through mounted switches. During the nighttime, that is problematic because the switches themselves are typically not illuminated. The lighting control board 26e comprises a relay configured to control activation of the lights 100. The relay can be hardwired to circuitry of the lights 100.

The controller 14 is configured to receive a command from the mobile electronic device 54 to activate or deactivate the lights 100 and to cause the wireless transmitter 50 of the controller 14 to transmit the command to the wireless receiver 76 of the base unit 24. The microcontroller 68 of the base unit 24 is configured to receive the command and cause the lighting control board 26e to control activation of the lights 100 in accordance with the command. The operator can thus activate the lights 100 via the human-machine interface 60 or the mobile electronic device 54 without having to trek to the mounted switch to activate the lights 100.

### (vii) Grain Temperature Sensor Board

The daughter board 26 may be a grain temperature sensor board 26f. The grain temperature sensor board 26f is configured to receive a signal from a temperature probe 104. The temperature probe 104 is configured to be disposed within the storage bin 22 and in contact with the grain 20 and to output a signal that changes as a function of grain 20 temperature. The temperature probe 104 can extend from the peripheral unit 16 into the storage bin 22 and into contact with the grain 20.

The microcontroller 68 of the base unit 24 is configured to receive the signal from the temperature probe 104 and cause the wireless transmitter 74 to transmit data corresponding to the signal to the wireless receiver 52 of the controller 14. The controller 14, in turn, is configured to determine the grain 20 temperature as a function of the signal from the temperature probe 104 and to push a notification 66 to the mobile electronic device 54 regarding the grain 20 temperature. The grain 20 temperature may be useful for override features or for alerting the operator to conditions that may warrant attention.

More particularly, excessively high or low grain 20 temperatures indicate conditions which threaten grain 20 and are to be avoided. To reduce moisture migration and condensation within the grain 20, it is essential that grain 20 temperatures be uniform throughout the storage bin 22. Override features may take precedence over aeration controlled solely as a function of ambient temperature and EMC. For example, a first override feature may take effect when the grain 20 temperature is not within a predetermined range (e.g., ±8° F.) of the running average temperature, causing the desired aeration fan 18 operation time to be doubled. A second override feature may call for aeration of the grain 20 regardless of other conditions when the grain 20 temperature exceeds the running average ambient temperature by greater than a threshold (e.g., 15° F.), the actual ambient air temperature is cooler than the grain 20 temperature by at least a threshold (e.g., 5° F.), and the actual ambient humidity is not greater than a threshold (e.g., 90 percent). A third override feature may call for aeration when the grain 20 temperature exceeds the running average temperature by a higher threshold (e.g., 30° F.) and the actual ambient air temperature is cooler than the grain 20 temperature by at least a threshold (e.g., 5° F.), regardless of humidity. The controller 14 may push a notification 66 to the mobile electronic device 54 that an override feature is warranted and occurring, or may request confirmation from the user via the mobile electronic device 54 before initiating the override feature.

### (viii) Static Pressure Sensor Board

The daughter board 26 may be a static pressure sensor board 26g. The static pressure sensor board 26g is configured to receive a signal from a static pressure sensor 106. The static pressure sensor 106 is configured to be disposed in the airflow 34 path between the aeration fan 18 and the grain 20 (e.g., in the conduit 44 or the plenum 42), for example downstream of the aeration fan 18. The static pressure sensor 106 is configured to output a signal that changes as a function of static pressure. The static pressure sensor 106 can rely upon piezoelectric or capacitive principles to output a voltage or other parameter that scales with pressure.

The microcontroller 68 of the base unit 24 is configured to receive the signal from the static pressure sensor 106 and cause the wireless transmitter 74 to transmit data corresponding to the signal to the wireless receiver 52 of the controller 14.

The controller 14 is configured to determine the static pressure as a function of the signal from the static pressure sensor 106 and to push a notification 66 to the mobile electronic device 54 regarding the static pressure. The controller 14 can determine the static pressure as a function of the voltage or whatever other signal is relayed to the controller 14. The controller 14 can compare the determined static pressure to a predetermined value (e.g., greater than 0). If the aeration fan 18 is operating, then the static pressure will be a positive value. If the aeration fan 18 is not operating, then the static pressure will be 0. There may be instances where the aeration fan 18 is drawing current but is not causing the airflow 34, which would be detrimental to the aeration of the grain 20. The controller 14 can be configured to cause the human-machine interface 60 to issue a notification 66 to the user when the static pressure is less than a predetermined value. The notification 66 may be “CHECK FAN” or “CHECK AIR FLOW PATH,” or something similar. The controller 14 may also push such a notification 66 to the mobile electronic device 54. The static pressure may be useful for determining how full the storage bin 22 is or for detecting issues with the aeration system.

### (ix) Weight Sensor Board

The daughter board 26 may be a weight sensor board 26h. The weight sensor board is configured to receive a signal from a weight sensor 108 (e.g., a scale). The scale/weight sensor 108 can be part of the farm operations 12 integrated into the system 10. The weight sensor 108 is configured to measure weight of grain 20 to be added to the storage bin 22. The microcontroller 68 of the base unit 24 is configured to receive the signal from the weight sensor 108 and cause the wireless transmitter 74 to transmit data corresponding to the signal to the wireless receiver 52 of the controller 14.

Before the grain 20 is delivered into the storage bin 22, it is helpful to know the weight of the grain 20. The weight of the grain 20 can be measured via the weight sensor 108 (scale) that communicates wirelessly the measured weight of the grain 20 to the controller 14 in anticipation of the grain 20 being delivered into the storage bin 22. The weight of the grain 20 may be measured by weighing a vehicle carrying the grain 20 before and after unloading, or by weighing the grain 20 directly as it is unloaded into a hopper or pit scale. This process of weighing and communicating can be repeated for successive loads of grain 20. The controller 14 determines the combined weight of the grain 20 from successive loads as a function of the signal from the weight sensor 108 and causes the human-machine interface 60 to issue a notification 66 to the operator that a predetermined percentage of a total capacity of the storage bin 22 has been occupied by grain 20 delivered thus far. The operator can then direct additional loads of the grain 20 to one or more other storage bins 22. The controller 14 may be further configured to push a notification 66 to the mobile electronic device 54 when a predetermined percentage of a total capacity of the storage bin 22 has been occupied by the grain 20. In embodiments, the weight of the grain 20 may factor into aeration decisions, as more grain 20 may require more aeration time to move air through the entire mass. The controller 14 may be configured to accept input from the human-machine interface 60 or the mobile electronic device 54 regarding weight and moisture content of grain 20 to be stored in the storage bin 22, and the controller 14 may be further configured to determine the schedule of activation of the aeration fan 18 to aerate the grain 20 as a function of the weight and moisture content.

### (x) Vent Pressure Sensor Board

The daughter board 26 may be a vent pressure sensor board 26i. The vent pressure sensor board 26i is configured to receive a signal from a pressure sensor 110 disposed proximate the vent 32 of the storage bin 22. The microcontroller 68 of the base unit 24 is configured to receive the signal from the pressure sensor 110 and cause the wireless transmitter 74 to transmit data corresponding to the signal to the wireless receiver 52 of the controller 14.

There is a problem in that debris 112 from the grain 20 has a tendency over time to fall through the perforations 40 in the floor 36 and accumulate within the plenum 42. That is a problem because the accumulated debris 112 in the plenum 42 reduces the volume of the airflow 34 that the aeration fan 18 is able to move through the grain 20 to perform the aeration thereof. The system 10 may include both a first peripheral unit 16 with a vent pressure sensor board 26i (pressure sensor 110 at the vent 32) and a second peripheral unit 16 with a static pressure sensor board 26g (static pressure sensor 106 in the airflow 34 path between the aeration fan 18 and the plenum 42). The controller 14 is configured to determine whether the plenum 42 is clogged as a function of the signals from both the pressure sensor 110 at the vent 32 and the static pressure sensor 106. If the comparison indicates a rising pressure at the static pressure sensor 106 with a steady or decreasing pressure at the pressure sensor 110 at the vent 32, then a potential cause would be the accumulation of debris 112 in the plenum 42, and the controller 14 causes the human-machine interface 60 to issue a notification 66 to the operator of such (e.g., “PLENUM CLOGGED”). The controller 14 may be further configured to push a notification 66 to the mobile electronic device 54 when the plenum 42 is determined to be clogged.

### (xi) Rotation Sensor Board

The daughter board 26 may be a rotation sensor board 26j. The rotation sensor board 26j is configured to receive a signal from a rotation sensor 114. The rotation sensor 114 is configured to be associated with the aeration fan 18 and to output a signal that changes as a function of whether blades 116 of the aeration fan 18 are rotating. The rotation sensor 114 may be an infrared, proximity, or magnetic sensor that generates a signal that changes as a function of the revolutions per minute of the axle turning the blades 116 of the aeration fan 18 or simply just the blades 116. The microcontroller 68 of the base unit 24 is configured to receive the signal from the rotation sensor 114 and cause the wireless transmitter 74 to transmit data corresponding to the signal to the wireless receiver 52 of the controller 14.

While the current sensor 84 associated with the aeration fan 18 is helpful for various aspects, the motor for the aeration fan 18 may be drawing a current but still not causing the blades 116 to rotate (and thus not causing any airflow 34). This could occur if a belt is broken, bearings are seized, or there is some other mechanical failure. The controller 14 is configured to determine whether the blades 116 of the aeration fan 18 are rotating as a function of the signal from the rotation sensor 114 and to push a notification 66 to the mobile electronic device 54 when the blades 116 are not rotating (e.g., “FAN BLADES NOT ROTATING”).

### (xii) CO₂ Sensor Board

The daughter board 26 may be a CO₂ sensor board 26k (also referred to as an exhaust sensor board). The CO₂ sensor board 26k is configured to receive a signal from a CO₂ sensor 118. The CO₂ sensor 118 is configured to be disposed proximate the vent 32 or exhaust of the storage bin 22 to detect CO₂ levels in the air 46 exiting the storage bin 22. The CO₂ sensor 118 outputs a signal that changes as a function of CO₂ levels. The microcontroller 68 of the base unit 24 is configured to receive the signal from the CO₂ sensor 118 and cause the wireless transmitter 74 to transmit data corresponding to the signal to the wireless receiver 52 of the controller 14. The controller 14 is configured to determine CO₂ levels as a function of the signal from the CO₂ sensor 118 and to push a notification 66 to the mobile electronic device 54 regarding the CO₂ levels. Elevated CO₂ levels may indicate grain 20 respiration, which could be a sign of spoilage or unfavorable storage conditions.

### (xiii) Volatile Organic Compound (VOC) Sensor Board

In embodiments, the daughter board 26 may be a volatile organic compound (VOC) sensor board (not separately illustrated). The VOC sensor board is configured to receive a signal from a VOC sensor. The VOC sensor is configured to be disposed proximate an entrance to the storage bin 22, such as near the top of the storage bin 22, to detect volatile organic compounds and toxins released by the grain 20. The VOC sensor may be a metal oxide semiconductor (MOS) sensor, a photoionization detector (PID), or an electrochemical sensor. The VOC sensor outputs a signal that changes as a function of VOC levels. The microcontroller 68 of the base unit 24 is configured to receive the signal from the VOC sensor and cause the wireless transmitter 74 to transmit data corresponding to the signal to the wireless receiver 52 of the controller 14. The controller 14 is configured to determine VOC levels as a function of the signal from the VOC sensor and to push a notification 66 to the mobile electronic device 54 when the VOC levels exceed a predetermined threshold. Elevated VOC levels may indicate unsafe conditions within the storage bin 22. Toxins released by the grain 20 can pose a serious health hazard to operators entering the storage bin 22, and the notification 66 can alert the operator to the unsafe condition before entry.

### (xiv) Vibration Sensor Board

In embodiments, the daughter board 26 may be a vibration sensor board (not separately illustrated). The vibration sensor board is configured to receive a signal from a vibration sensor. The vibration sensor is configured to be associated with the aeration fan 18, the electric motor 86 of the auger 88, the electric motor 94 of the grain leg 90, or other equipment and to output a signal that changes as a function of vibration. The microcontroller 68 of the base unit 24 is configured to receive the signal from the vibration sensor and cause the wireless transmitter 74 to transmit data corresponding to the signal to the wireless receiver 52 of the controller 14. The controller 14 is configured to determine vibration levels as a function of the signal from the vibration sensor. The controller 14 may be further configured to learn normal vibration levels after initial installation of the vibration sensor and to identify deviations from the learned normal vibration levels. The controller 14 is configured to push a notification 66 to the mobile electronic device 54 when the vibration deviates from the learned normal vibration levels or is otherwise outside a predetermined range. Abnormal vibration levels may indicate worn bearings, imbalanced components, or other mechanical issues that warrant attention before equipment failure occurs.

### (xv) Time-of-Flight (ToF) Sensor Board

In embodiments, the daughter board 26 may be a time-of-flight (ToF) sensor board (not separately illustrated). The ToF sensor board is configured to receive a signal from a ToF sensor. The ToF sensor may be a LIDAR sensor, a radar sensor, or other sensor that emits pulses and measures the time for the pulses to reflect back from a surface. The ToF sensor is configured to be disposed within the storage bin 22 and to output a signal that changes as a function of distance to the grain 20 surface. The ToF sensor emits pulses and measures the time for the pulses to reflect back from the grain 20 surface, thereby determining the distance to the grain 20 surface. The microcontroller 68 of the base unit 24 is configured to receive the signal from the ToF sensor and cause the wireless transmitter 74 to transmit data corresponding to the signal to the wireless receiver 52 of the controller 14. The controller 14 is configured to determine the level of grain 20 within the storage bin 22 as a function of the signal from the ToF sensor and to push a notification 66 to the mobile electronic device 54 regarding the grain 20 level. The ToF sensor may be useful for determining how full the storage bin 22 is or for detecting changes in grain 20 level over time. Because grain 20 volume decreases as moisture is released from the grain 20 and increases as moisture is absorbed by the grain 20, the controller 14 may be further configured to determine moisture content of the grain 20 as a function of changes in the grain 20 level detected by the ToF sensor. The controller 14 may be further configured to adjust the aeration schedule as a function of the determined moisture content.

### (xvi) Infrared Sensor Board

In embodiments, the daughter board 26 may be an infrared sensor board (not separately illustrated). The infrared sensor board is configured to receive a signal from an infrared sensor. The infrared sensor is configured to be disposed proximate the vent 32 or exhaust of the storage bin 22 and to output a signal that changes as a function of infrared radiation emitted by the air 46 exiting the storage bin 22. The microcontroller 68 of the base unit 24 is configured to receive the signal from the infrared sensor and cause the wireless transmitter 74 to transmit data corresponding to the signal to the wireless receiver 52 of the controller 14. The controller 14 is configured to determine the temperature of the air 46 exiting the storage bin 22 as a function of the signal from the infrared sensor. When the aeration fan 18 is moving relatively cool air 46 through the grain 20 mass, the infrared sensor detects the cooler air 46 exiting the storage bin 22, indicating that the grain 20 has cooled down. The controller 14 may be further configured to automate the transition from a drying mode to a storage mode as a function of the signal from the infrared sensor. The controller 14 may be further configured to adjust the aeration schedule as a function of the signal from the infrared sensor and to push a notification 66 to the mobile electronic device 54 regarding the transition from drying mode to storage mode.

As the discussion above for the vent pressure sensor board 26i foretells, the system 10 may include a plurality of peripheral units 16. Each peripheral unit 16 has a different daughter board 26 configured to provide different functionality. For example, the system 10 may include a first peripheral unit 16 with a fan control board 26b1, a second peripheral unit 16 with an ambient temperature and humidity sensor board 26a, a third peripheral unit 16 with a fan sensor board 26b2, a fourth peripheral unit 16 with an auger control board 26c, and so on. Each peripheral unit 16 has a unique address for identification by the controller 14, so the controller 14 can distinguish between signals received from different peripheral units 16.

The controller 14 may be configured to control aeration of grain 20 stored in multiple storage bins 22. If all storage bins 22 have the same airflow capacity (CFM) and store the same commodity, the controller 14 may run the same aeration program for all bins 22. If the storage bins 22 have different airflow capacities or store different commodities, the controller 14 may run different aeration programs for each bin 22. The controller 14 may be configured to calculate the airflow capacity as a function of the size of the aeration fan 18 and the size of the storage bin 22, which the controller 14 can receive as input via the mobile electronic device 54 or the human-machine interface 60. This allows a single controller 14 to manage multiple storage bins 22 without requiring separate control units for each bin 22.

Weather data collected by the controller 14 (from the temperature sensor 78 and the humidity sensor 80 of a peripheral unit 16 with an ambient temperature and humidity sensor board 26a) of an installation of the system 10 at one location can be utilized to control aspects of the system 10 at another location. In short, the weather data from one location can affect the activation and/or run time of the aeration fan 18 at another location.

The controller 14 may be configured to receive data from a temperature sensor 78 and a humidity sensor 80 of one or more other systems 10 located at different geographic positions relative to the storage bin 22. The controller 14 may receive such data via the internet, a cloud server, a cellular network, or direct long-range wireless communication (such as LoRa) with the other systems 10. By comparing the temperature and humidity data from these other systems 10 to the local temperature and humidity data, the controller 14 may determine whether a weather front is advancing toward the storage bin 22. For example, if a system 10 located to the west of the storage bin 22 reports a significant change in temperature or humidity (such as a sudden drop in temperature or a sudden increase in humidity), and this change is not yet reflected in the local temperature and humidity data, the controller 14 may determine that a weather front is advancing from the west toward the storage bin 22. In response, the controller 14 may activate the aeration fan 18 proactively to aerate the grain 20 before the weather front arrives, thereby maintaining equilibrium between the grain 20 and the ambient conditions and reducing the likelihood of condensation or moisture development when the weather front passes through. Alternatively, the controller 14 may extend the runtime of the aeration fan 18 until the weather front arrives, understanding that the weather front will bring conditions resulting in deactivation of the aeration fan 18. In such instances, the temperature sensor 78 and/or the humidity sensor 80 may be part of a sensor unit that further includes a barometric sensor 82 that can provide additional useful data for the controller 14 for understanding the presence of the weather front. Data from many systems 10 can be collected, enhancing weather forecasting for each of those systems 10. The controller 14 may be configured to perform machine learning to learn the weather pattern in a given geographical area in which the system 10 is located over a period of time as a function of input from the temperature sensor 78 and the humidity sensor 80. The controller 14 may be further configured to determine whether to activate the aeration fan 18 to aerate the grain 20 as a function of the learned weather pattern.

While the system 10 has been described thus far in terms of the controller 14 communicating and/or receiving communications through the one or more peripheral units 16, the controller 14 can be configured to communicate and/or receive communications directly from the component that would otherwise communicate through the peripheral unit 16 (e.g., the current sensor 84). For example, the system 10 can include the controller 14, human-machine interface 60, and the current sensor 84, with or without the peripheral unit 16 being connected to the current sensor 84. In either case, the current sensor 84 is operably connected to the aeration fan 18 and outputs a signal that changes as a function of current that the aeration fan 18 draws. The controller 14 is in communication with the current sensor 84 and the human-machine interface 60. The controller 14 is configured to activate the aeration fan 18, to determine the current that the aeration fan 18 is drawing when activated as a function of the signal from the current sensor 84, and to cause the human-machine interface 60 to issue a notification 66 to a user when the current that the aeration fan 18 is drawing is outside a predetermined range. The controller 14 can push the notification 66 to the mobile electronic device 54, as discussed. The data from the current sensor 84 can be hardwired to the controller 14 or can be sent via wireless transmitter (via the peripheral unit 16 as described or otherwise) to the controller 14. The functionality that each of the components described above provides may be achieved via direct wired connection between the component and the controller 14 or via a wireless transmitter associated with the component that communicates with the controller 14 without utilizing the peripheral unit 16.

The system 10 may further comprise the temperature sensor 78 configured to output a signal that changes as a function of ambient air temperature and the humidity sensor 80 configured to output a signal that changes as a function of ambient air relative humidity, wherein the controller 14 is in communication with the temperature sensor 78 and the humidity sensor 80. The controller 14 may be further configured to perform the EMC-based aeration control as described above. The temperature sensor 78 and the humidity sensor 80 can be hardwired to the controller 14 or can be sent via wireless transmitter (via the peripheral unit 16 as described or otherwise) to the controller 14. As mentioned, the controller 14 may be further configured to communicate with the mobile electronic device 54, to accept input from the mobile electronic device 54 as a duplicate of the human-machine interface 60, and to cause the mobile electronic device 54 to issue the notification 66.

An overarching aspect of the disclosure is the ability of the user to control the system 10 directly with the mobile electronic device 54 without a central computer intermediary and without having to be physically present at the human-machine interface 60 associated with the controller 14. In embodiments, the system 10 includes the human-machine interface 60 and the controller 14 in direct communication with the human-machine interface 60. However, the controller 14 is configured to activate the aeration fan 18 or perform any other of the farm operations 12 (e.g., control the lights 100) via user command issued through wireless communication with the mobile electronic device 54 and without requiring a central computer intermediary. The controller 14 accepts input from the mobile electronic device 54 as a duplicate of the human-machine interface 60. The controller 14 can push a notification 66 to the mobile electronic device 54 regarding a status of the aeration fan 18 or any other of the farm operations 12 (e.g., the lights 100, the electric motor 86 of the auger 88, etc.).

As a more particular example, because the controller 14 is in communication with the temperature sensor 78 and the humidity sensor 80, the controller 14 may be further configured to push a notification 66 to the mobile electronic device 54 regarding the ambient air temperature or the ambient air relative humidity. Similarly, the controller 14 may be further configured to perform the EMC-based aeration control as described above and to push a notification 66 to the mobile electronic device 54 regarding the EMC. The input accepted from the mobile electronic device 54 may include one or more of grain 20 type, desired grain 20 moisture content, desired time of daily fan operation, a command to activate or deactivate the aeration fan 18, a command to activate or deactivate the auger 88, a command to activate or deactivate the grain leg 90, or a command to activate or deactivate the lights 100, and so on.

The controller 14 may be configured to collect operational data during aeration of the grain 20. Data from the controller 14 can be sent to a service center for evaluation of suboptimal running conditions. The service center can notify the end user as well as service technicians when there is an issue with the system 10 operation. The service center can access data from each system 10 remotely and can upload system updates, software updates, and new code over the air through the cellular modem, WiFi, or other wireless protocols. In keeping with the proactive approach described throughout the disclosure, the service center can help prevent issues with the stored grain 20, electric motors 86, 94, and augers 88 before they become significant problems.

In the circumstance of certain specialty grains 20, the controller 14 may be configured to compile conditioning data in a format that is easily readable for the grain 20 processor to ensure the condition of the specialty grain 20 being delivered. This may be accomplished by data logging run times and moisture targets. The data logging may also include data from the CO₂ sensor 118 showing no CO₂ respiration of the grain 20, which can provide assurance that the grain 20 has been stored under favorable conditions.

While the system 10 has been discussed in terms of improvements to grain 20 aeration, various aspects of the system 10 can be utilized for improvements concerning the storage bin 22 and storage of the grain 20 therein generally. More broadly, the system 10 can control various aspects of farm operations 12, with aeration being one function among many. The system 10 of the present disclosure addresses the problems described in the Background in a variety of ways. With respect to the first problem (aeration fan 18 as a chokepoint), the current sensor 84 and the static pressure sensor 106, together and separately, permit the controller 14 to determine that the aeration fan 18 has become inoperable or is not operating optimally to move air through the grain 20. The controller 14 causes the human-machine interface 60 to issue a notification 66 of such information to the operator. The operator can then take remedial action before the grain 20 spoils due to lack of aeration. With respect to the second problem (operator must be physically present at the control box), the mobile electronic device 54 functions as a duplicate of the human-machine interface 60, so the operator can be essentially anywhere and receive the information and issue commands without being physically present at the storage bin 22. With respect to the third problem (control apparatus is purpose-built for grain 20 aeration), the modular peripheral unit 16 design with interchangeable daughter boards 26 allows a common base unit 24 to be adapted for controlling different farm equipment including aeration fans 18, augers 88, grain legs 90, and lighting. With respect to the fourth problem (wired connections for sensors), all of the sensors described herein, including the temperature probes 104 within the storage bin 22, the current sensor 84, and the static pressure sensor 106, have wireless communication capability. Installation thus becomes easier and less expensive without the need for cabling.

It will be apparent to those skilled in the art that various modifications and variations can be made without departing from the spirit or scope of the claims.

What is claimed is:

1. A system for controlling farm operations comprising:
a controller configured to activate an aeration fan for aeration of grain stored in a storage bin, the controller comprising a wireless transmitter and a wireless receiver;
at least one peripheral unit in communication with the controller, each of the at least one peripheral units comprising a base unit and an interchangeable daughter board, the base unit comprising a microcontroller, a printed circuit board, a power source, a wireless transmitter, and a wireless receiver, the daughter board in this instance being a fan control board comprising a relay configured to control activation of the aeration fan, wherein the controller is configured to cause the wireless transmitter of the controller to transmit a command to the wireless receiver of the base unit to activate or deactivate the aeration fan, and wherein the microcontroller of the base unit is configured to receive the command and cause the fan control board to control activation of the aeration fan in accordance with the command; and
optionally one or more additional peripheral units having daughter boards selected from:
(i) an ambient temperature and humidity sensor board,
(ii) a fan sensor board configured to monitor current drawn by the aeration fan,
(iii) an auger control board configured to control, and optionally monitor, an electric motor of an auger,
(iv) a grain leg control board configured to control, and optionally monitor, an electric motor of a grain leg,
(v) a lighting control board configured to control lights proximate the storage bin,
(vi) a grain temperature sensor board,
(vii) a static pressure sensor board,
(viii) a weight sensor board,
(ix) a vent pressure sensor board,
(x) a rotation sensor board,
(xi) a CO₂ sensor board,
(xii) a volatile organic compound (VOC) sensor board,
(xiii) a vibration sensor board,
(xiv) a time-of-flight (ToF) sensor, and
(xv) an infrared sensor.

2. The system of claim 1, wherein
the power source of the base unit comprises a battery pack capable of solar recharge or a 120V input.

3. The system of claim 1, wherein
the peripheral unit comprises a unique address for identification by the controller.

4. The system of claim 1 further comprising:
a plurality of peripheral units, each peripheral unit having a different daughter board configured to provide different functionality.

5. The system of claim 1, wherein
the controller is further configured to communicate with a mobile electronic device and to accept input from the mobile electronic device to control functionality provided by the daughter board of the peripheral unit.

6. The system of claim 5, wherein
the controller is further configured to push a notification to the mobile electronic device regarding a status of the functionality provided by the daughter board of the peripheral unit.

7. The system of claim 5, wherein
the daughter board is the fan sensor board, wherein the fan sensor board comprises a current sensor configured to be operably connected to the aeration fan and to output a signal that changes as a function of current that the aeration fan draws, and
wherein the microcontroller of the base unit is configured to receive the signal from the current sensor and cause the wireless transmitter to transmit data corresponding to the signal to the wireless receiver of the controller, and
wherein the controller is further configured to determine the current drawn by the aeration fan as a function of the signal from the current sensor and to push a notification to the mobile electronic device when the current is outside a predetermined range.

8. The system of claim 5, wherein
the daughter board is the auger control board, wherein the auger control board comprises a relay configured to control activation of an electric motor of an auger for a grain unloading system, and
wherein the controller is further configured to receive a command from the mobile electronic device to activate or deactivate the electric motor and to cause the wireless transmitter of the controller to transmit the command to the wireless receiver of the base unit, and wherein the microcontroller of the base unit is configured to receive the command and cause the auger control board to control activation of the electric motor in accordance with the command.

9. The system of claim 5, wherein
the daughter board is the grain leg control board, wherein the grain leg control board comprises a relay configured to control activation of an electric motor of a grain leg, and
wherein the controller is further configured to receive a command from the mobile electronic device to activate or deactivate the electric motor and to cause the wireless transmitter of the controller to transmit the command to the wireless receiver of the base unit, and wherein the microcontroller of the base unit is configured to receive the command and cause the grain leg control board to control activation of the electric motor in accordance with the command.

10. The system of claim 5, wherein
the daughter board is the lighting control board, wherein the lighting control board comprises a relay configured to control activation of lights proximate the storage bin, and
wherein the controller is further configured to receive a command from the mobile electronic device to activate or deactivate the lights and to cause the wireless transmitter of the controller to transmit the command to the wireless receiver of the base unit, and wherein the microcontroller of the base unit is configured to receive the command and cause the lighting control board to control activation of the lights in accordance with the command.

11. The system of claim 5, wherein
the daughter board is the grain temperature sensor board, the grain temperature sensor board configured to receive a signal from a temperature probe, the temperature probe configured to be disposed within the storage bin and in contact with the grain and to output a signal that changes as a function of grain temperature, wherein the microcontroller of the base unit is configured to receive the signal from the temperature probe and cause the wireless transmitter to transmit data corresponding to the signal to the wireless receiver of the controller, and
wherein the controller is further configured to determine the grain temperature as a function of the signal from the temperature probe and to push a notification to the mobile electronic device regarding the grain temperature.

12. The system of claim 5, wherein
the daughter board is the static pressure sensor board, the static pressure sensor board configured to receive a signal from a static pressure sensor, the static pressure sensor configured to be disposed in an airflow path between the aeration fan and the grain and to output a signal that changes as a function of static pressure, wherein the microcontroller of the base unit is configured to receive the signal from the static pressure sensor and cause the wireless transmitter to transmit data corresponding to the signal to the wireless receiver of the controller, and
wherein the controller is further configured to determine the static pressure as a function of the signal from the static pressure sensor and to push a notification to the mobile electronic device regarding the static pressure.

13. The system of claim 5, wherein
the daughter board is the weight sensor board, the weight sensor board configured to receive a signal from a weight sensor, the weight sensor configured to measure weight of grain to be added to the storage bin, wherein the microcontroller of the base unit is configured to receive the signal from the weight sensor and cause the wireless transmitter to transmit data corresponding to the signal to the wireless receiver of the controller, and
wherein the controller is further configured to determine a combined weight of the grain from successive loads as a function of the signal from the weight sensor and to push a notification to the mobile electronic device when a predetermined percentage of a total capacity of the storage bin has been occupied by the grain.

14. The system of claim 5, further comprising:
a first peripheral unit having a vent pressure sensor board as the daughter board, the vent pressure sensor board configured to receive a signal from a pressure sensor disposed proximate a vent of the storage bin; and
a second peripheral unit having a static pressure sensor board as the daughter board, the static pressure sensor board configured to receive a signal from a static pressure sensor disposed in an airflow path between the aeration fan and a plenum below a floor with perforations that support the grain in the storage bin;
wherein the controller is further configured to determine whether the plenum is clogged as a function of the signals from the pressure sensor and the static pressure sensor and to push a notification to the mobile electronic device when the plenum is determined to be clogged.

15. The system of claim 5, wherein
the daughter board is the rotation sensor board, the rotation sensor board configured to receive a signal from a rotation sensor, the rotation sensor configured to be associated with the aeration fan and to output a signal that changes as a function of whether blades of the aeration fan are rotating, wherein the microcontroller of the base unit is configured to receive the signal from the rotation sensor and cause the wireless transmitter to transmit data corresponding to the signal to the wireless receiver of the controller, and
wherein the controller is further configured to determine whether the blades of the aeration fan are rotating as a function of the signal from the rotation sensor and to push a notification to the mobile electronic device when the blades are not rotating.

16. The system of claim 1, wherein
the daughter board is the ambient temperature and humidity sensor board, the ambient temperature and humidity sensor board comprising a temperature sensor configured to output a signal that changes as a function of ambient air temperature and a humidity sensor configured to output a signal that changes as a function of ambient air relative humidity, wherein the microcontroller of the base unit is configured to receive the signals from the temperature sensor and the humidity sensor and cause the wireless transmitter to transmit data corresponding to the signals to the wireless receiver of the controller, and
wherein the controller is further configured
(i) to determine and store a current ambient air temperature as a function of the signal from the temperature sensor,
(ii) to determine and store a running average ambient air temperature from the current ambient air temperature as a function of time,
(iii) to compare a current ambient air temperature to the running average ambient air temperature,
(iv) to determine an equilibrium moisture content (EMC) corresponding to a type of grain stored as a function of the signals from the temperature sensor and the humidity sensor,
(v) to compare the EMC to a desired grain moisture content, and
(vi) to activate the aeration fan when the current ambient air temperature is within a predetermined acceptable range from the running average ambient air temperature and the EMC is within a predetermined acceptable range from the desired grain moisture content.

17. The system of claim 16, wherein
the controller is further configured to communicate with a mobile electronic device and to push a notification to the mobile electronic device regarding the EMC.

18. The system of claim 1, wherein
the controller is further configured to receive data from a temperature sensor and a humidity sensor of one or more other systems to determine whether a weather front is advancing toward the storage bin and to activate the aeration fan as a consequence.

19. A system for controlling aeration of grain stored in a storage bin comprising:
a current sensor configured to be operably connected to an aeration fan and to output a signal that changes as a function of current that the aeration fan draws;
a human-machine interface; and
a controller in communication with the current sensor and the human-machine interface, the controller configured (i) to activate the aeration fan, (ii) to determine the current that the aeration fan is drawing when activated as a function of the signal from the current sensor, and (iii) to cause the human-machine interface to issue a notification to a user when the current that the aeration fan is drawing is outside a predetermined range.

20. A system for controlling aeration of grain stored in a storage bin comprising:
a human-machine interface;
a controller in direct communication with the human-machine interface, the controller configured (i) to activate an aeration fan, (ii) to wirelessly communicate with a mobile electronic device without requiring a central computer intermediary, (iii) to accept input from the mobile electronic device as a duplicate of the human-machine interface, and (iv) to push a notification to the mobile electronic device regarding a status of the aeration fan.
